(19) United States
(12) Patent Application Publication
(10) Pub. No.: US 2005/0154614 A1
(43) Pub. Date: Jul. 14, 2005

(54) System and method for providing a national medical records database

(76) Inventors: Ian S. Swanson, Weston, CT (US); Mitchell D. Dimler, Trabuco Canyon, CA (US); John M. Specht, Setauket, NY (US)

Correspondence Address: PILLSBURY WINTHROP SHAW PITTMAN LLP, 1650 TYSONS BOULEVARD, MCLEAN, VA, 22102, US

(21) Appl. No.: 10/978,394

(22) Filed: Nov. 2, 2004

Related U.S. Application Data
(60) Provisional application No. 60/516,269, filed on Nov. 3, 2003.

(51) Int. Cl. G06F 17/60

(52) U.S. Cl. 705/3

(57) ABSTRACT

The present invention relates to a system and associated method for providing a national medical database. A medical record is scanned at a facility of a first client, and clinical data is extracted from the record. The clinical data into a clinical outcomes database, and the personal data is stored in a personal data database. Access to the clinical data is provided to the first client and a second client. Access to the personal data is provided only to the first client providing access to the clinical outcomes database to the first client and a second client.

This application claims the benefit of U.S. Provisional Application No. 60/516,269, filed Nov. 3, 2003, which is herein incorporated by reference in its entirety.

### BACKGROUND OF THE INVENTION

1. Field of the Invention

Embodiments of the present invention relate to a system and method for providing a national medical database. More particularly, embodiments of the present invention relate to systems and methods for developing a database of clinical data that can be used by pharmaceutical companies, health care providers, and health care payers.

2. Background Information

Pharmaceutical companies, health care providers, and health care payers often invest significant time and money collecting, storing, assimilating and analyzing data from medical records or other sources of clinical data for research or other purposes. For example, pharmaceutical companies may gather such data to evaluate the performance of pharmaceuticals in treatment. They may evaluate pharmaceuticals produced by them, or those produced by their competitors. Similarly, health care providers, such as hospitals, may gather clinical data from medical records or other sources to perform research, such as discovering behavioral trends of patients, improving methods for diagnosing patients, assessing treatment effectiveness, and other research related to the provision of health care. Likewise, health care payers may gather and review clinical data to determine which types of treatments to provide, the expected costs of those treatments and other treatment-related information. For example, it may approve only the most cost efficient forms of treatment.

Although pharmaceutical companies, health care providers and health care payers generally perform research based upon the same or similar clinical data, each entity typically gathers its own data for such research. For example, a pharmaceutical company may hire a technician to collect clinical data from a large volume of hardcopy or paper medical documents. Because these documents have numerous, non-standard formats, the technician often must transcribe the clinical data from each document by hand. Similarly, a health care provider may hire a technician or company to perform the same type of work. Particularly, the health care provider may hire a technician to collect clinical data from its voluminous historic (also called “backplant”) information by transcribing data from each document by hand. Because of the large volume of documents to be reviewed and the non-standard format of the documents, a significant cost is associated with such transcription for each entity seeking clinical data.

Another problem with collecting data is ensuring compliance with the Health Insurance Portability and Accountability Act (“HIPAA”). HIPAA establishes national standards for electronic health care transactions to ensure the security and privacy of health data. The privacy standards extend not only to health care payers, health care clearinghouses and certain health care providers, but also to business associates of such covered entities. Under HIPAA, a business associate is a person or entity who provides certain functions, activities, or services for or to a covered entity, involving the use and/or disclosure of protected health information. Business associates must provide satisfactory assurances, typically by a business associate agreement or other contract, to the payer, provider or other covered entity including that the business associate will use the information only for the purposes for which they were engaged by the covered entity and will safeguard the information from misuse. Protected health information may be disclosed to a business associate only to help the providers and plans carry out their health care functions—not for independent use by the business associate. HIPAA also establishes the conditions under, which protected health information may be used or disclosed by covered entities for research purposes. Many companies today who may wish to provide data collection'services do not have the capabilities to comply with HIPAA.

Thus, what is needed is a data collection procedure for collecting clinical data into a database that complies with HIPAA guidelines and can be used by pharmaceutical companies, health care providers and health care payers alike.

### SUMMARY OF THE INVENTION

The present invention relates to a system and associated method for building a database. The description herein may be applicable to any situation whereby an electronic database is created from a large volume of documents, especially non-standard documents. By way of example, a medical records application is used herein to describe the system and method. One of ordinary skill in the art will, however, understand that the invention is not limited only to a medical records application, but is suitable for any situation whereby a database is created to store information contained in hardcopy documents.

### BRIEF DESCRIPTION OF THE DRAWINGS

FIG. 1 is a schematic diagram showing a data collection system according to an exemplary embodiment of the present invention.

FIG. 2 is a flowchart showing an exemplary method for providing an end-to-end data collection system according to an embodiment of the present invention.

FIG. 3 is a schematic diagram of a data capture process according to an exemplary embodiment of the present invention.

FIG. 4 is a schematic diagram of a data analysis process according to an exemplary embodiment of the present invention.

FIG. 5 is a schematic diagram of a data access process according to an exemplary embodiment of the present invention.

FIG. 6 is a schematic diagram of an exemplary data access system for the provider client according to an embodiment of the present invention.

### DETAILED DESCRIPTION OF THE INVENTION

Embodiments of systems and methods related to developing a national medical database are described in this detailed description of the invention. In this detailed description, for purposes of explanation, numerous specific details are set forth to provide a thorough understanding of embodiments of the present invention. One skilled in the art will appreciate, however, that embodiments of the present invention may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of embodiments of the present invention.

Embodiments of the present invention include a method for developing a national medical database. According to an embodiment of the invention, a database builder scans medical records or other documents at a facility of a health care provider and process the scanned records. The database builder extracts clinical data, personal information, and a document image from each medical record and store the components in a separate databases. In particular, the database builder stores the clinical data, which is not protected under HIPAA, in a separate database from the personal information and document image, which are protected. For example, the clinical data can be stored in a national medical database that is accessed by the health care provider, as well as other health care providers, health care payers, pharmaceutical companies, and others. In contrast, the personal information and document image can be returned to the health care provider or stored in one or more databases that are accessible only by the health care provider.

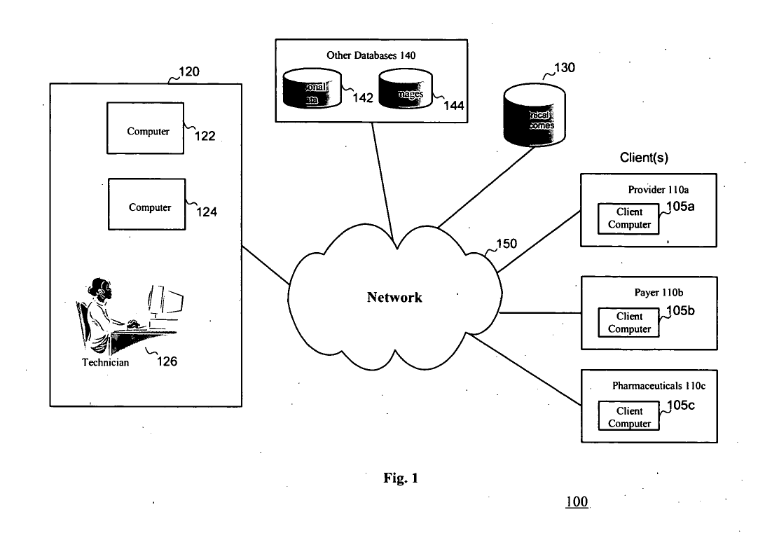

FIG. 1 depicts an exemplary data collection system 100 according to an embodiment of the present invention. Data collection system 100 can be implemented in a medical, pharmaceutical, administrative or other setting. Data collection system 100 includes one or more client computer systems 105a-105c associated with one or more clients 110a-110c, a database builder 120, a clinical outcomes database 130, other databases 140 and a network 150.

In one embodiment of the present invention, client computer systems 105a-105c include computer systems associated with clients 110a-110c, respectively. Clients 110a-110c include health care providers 110a, health care payers 110b, pharmaceutical companies 110c, and/or any other entity that could benefit from data collection system 100. Health care providers 110a include clinics, hospitals, emergency rooms, physicians' offices, and/or any other care delivery organization (“CDO”). CDOs deliver health care to their patients. Health care payers 110b include insurance companies, HMOs, and/or any other payment provider. Pharmaceutical companies 110c include any pharmaceutical companies, such as, for example, any company or organization that manufactures, uses, supplies or imports pharmaceuticals, medications, or other prescription or non-prescription drugs.

Database builder 120 is adapted to provide the necessary functionality and computing capabilities to gather and analyze raw data from clients 110a-110c, as well as ensure that only authorized employees with user identifications and passwords have access to its facilities. Raw data includes any data gathered from clients 110a-110c, such as medical records or other documents. The results of analyzing the raw data are provided as output from database builder to clinical outcomes database 130 and other databases 140. Any of these databases can be utilized as persistent storage devices. For example, in one embodiment of the present invention, clinical outcomes database 130 includes a database for storing clinical data extracted from the raw data. The clinical data is any clinical data. For example, the clinical data can reflect the effectiveness of diagnosis, treatment, pharmaceuticals. In an embodiment of the present invention, other databases 140 include a first database 142 for recording personal data extracted from the raw data, a second database 144 for recording images of the raw data, and any other database.

Extracted clinical data stored in clinical outcomes database 130 can be accessed electronically by each client 110a-110c including other health care providers 110a. In one embodiment of the present invention, data is provided electronically via network 150 to computer systems or system devices 105a-105c associated with clients 110a-110c, respectively. Alternatively, the data stored in clinical outcomes database 130 is mailed to each of clients 110a-110c in hardcopy form via a delivery service. Such delivery services include, for example, the U.S. postal service, Federal Express, United Parcel Service and other delivery services. On the other hand, data stored in other databases 140 is available only to the particular client 110a that physically or electronically supplied the raw data. The data stored in other databases 140 is provided electronically via network 150 or in hardcopy form via a delivery service as described above. In an embodiment of the present invention, health care provider 110a supplies the raw data and receives data stored in other databases 140. Although health care provider 110a is described herein as the supplier or provider of medical records or other documents, one skilled in the art will recognize that other clients may provide such data.

In the embodiment of FIG. 1, database builder 120 comprises computer systems 122 and 124 and one or more technicians 124 for performing various functions and operations of the invention. Alternatively, database builder 120 performs all of the various functions and operations of the invention without the use of a human operator or technician 126. Computer systems 122 and 124 are general purpose computers selectively activated or reconfigured by a computer program. Alternatively, computer systems 122 and 124 are specially constructed computer platforms for carrying-out the features and operations of the present invention as described herein.

In one embodiment of the present invention, computer system 122 is a mainframe computer, laptop, personal computer or any other computer system that is located at a fixed facility or site of database builder 120, and computer system 124 is a personal computer, laptop, or any other computer system that is located in a mobile site or facility of database builder 120. For example, computer system 122 can be located at the headquarters or a business unit of database builder 120; whereas, computer system 124 can be located in a vehicle or trailer that may be transported by technician 126. Although computer systems 122 and 124 are described herein as separate computer systems, one of ordinary skill in the art will appreciate that the functions of the invention may be performed on a single computer system or any number of computer systems or platforms.

As indicated above, database builder 120 communicates or transfers clinical outcomes data to and from client computer systems 105a-105c through network 150. In one embodiment of the invention, network 150 comprises, alone or in any suitable combination, a telephony-based network (such as the PSTN), a local area network (LAN), a wide area network (WAN), a dedicated intranet, and/or the Internet. Further, any suitable combination of wired and/or wireless components and systems may be incorporated into network 150.

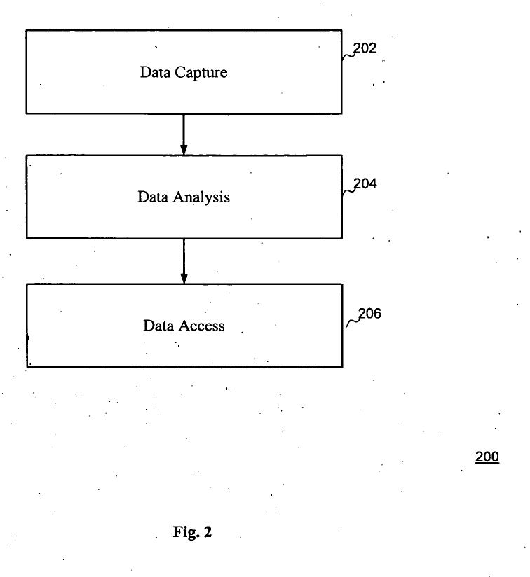

FIG. 2 is a flow chart of a process 200 for providing an end-to-end data collection system according to an embodiment of the present invention. As illustrated in FIG. 2, in step 200, technician 126 of database builder 120 performs data capture to obtain raw data from a provider client, such as health care provider 110a. Technician 126 may travel to one or more facilities-specified by or associated with the provider client to scan medical records or other documents located at the facilities.

One of ordinary skill in the art will recognize that such facilities may be owned, leased, managed or rented by the provider client. Alternatively, the facilities can be owned, leased, managed or rented by another entity performing services for the provider client. For example, the provider client may hire an entity, such as a company, to store and manage its medical records and other documents. The facilities can be provided at a location remote to the location of the provider client. Alternatively, the facilities can be co-located with the location of the provider client.

After capturing the data, database builder then analysis the data in step 204. In one embodiment of the present invention, technician 126 may enter data derived from the scanned images of medical records or other documents into clinical outcomes database 130 and other databases 140. For example, technician 126 may extract clinical data from the medical records and store it in clinical outcomes database 130. Similarly, technician 126 may extract personal data from the medical records and store it in first database 142 of other databases 140 and/or store images of the records in second database 144 of other databases 140. One of ordinary skill in the art will recognize that in addition to the extracted data described above other databases 140 or clinical outcomes database 130 can store other data.

In an embodiment of the present invention, technician 126 tags unique identifiers onto the various components (clinical data, personal data, and the document image) for a particular record when he or she physically separates the components of a medical record. In this way, a complete record of a patient of provider client (containing clinical data, personal data and the document image) can be provided to the provider client when needed.

In another embodiment of the invention, technician 126 further processes data in clinical outcomes database 130 to categorize clinical data containing particular symptoms, treatments, prescriptions, or other categories of clinical data. For example, technician 126 may categorize clinical data relating to a pharmaceutical used during treatment so that clients may evaluate the effectiveness of that pharmaceutical. Similarly, database builder 120 can categorize clinical data according to a particular ailment to highlight the effectiveness of various forms of treatments provided by health care providers.

In step 204, access is provided to the storage databases. For example, as described above, in step 204, database builder 120 can provide the data stored in clinical outcomes database 130 to the provider client and third parties. Further, in step 204, database builder 120 can provide access to the data stored in other databases 140 to the provider client only.

Third parties include any client 110a-110c other than the provider client. For example, a health care provider may view clinical data of its own patients as well as clinical data from every other health care provider 110a in data collection system 100. By providing third parties access to clinical data, while at the same time safeguarding the corresponding personal data, the present invention facilitates compliance with HIPAA.

As described above, the data stored in clinical outcomes database 130 is provided to clients 110a-110c in any of a number of ways. In one embodiment, a client views the data electronically over a network, such as the Internet, or in an e-mail attachment received from the network. A variety of billing options are available. For example, the client can opt to pay a fee for unlimited electronic access to the data. Alternatively, a client can elect to access the data at periodic intervals or on a pay-per-use basis.

Database builder 120 sends a notification to a client regarding the status or availability of the data for review after capture. In another embodiment, a client accesses or attempts to access database 130 to review the status or availability of the data for review.

In another embodiment of the present invention, the data is mailed to a client in hardcopy or electronic form. For example, a client can receive the data analysis on a storage disk or as a paper print-out.

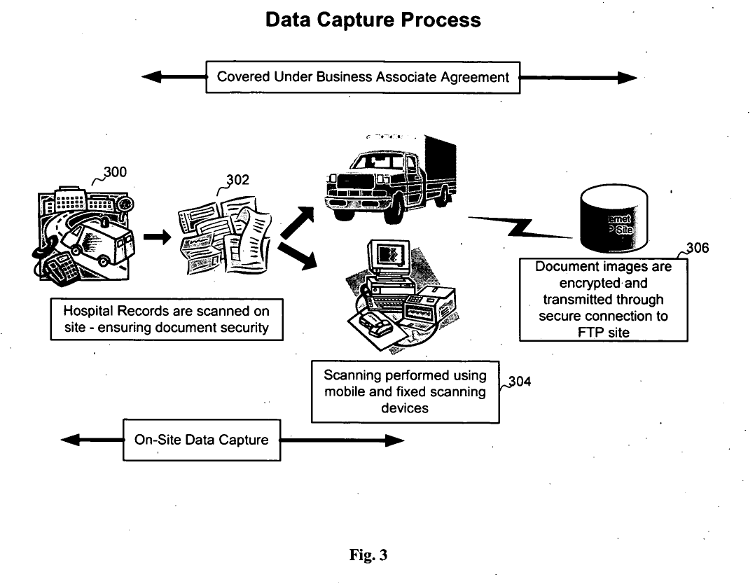

FIG. 3 is a schematic diagram of a flow chart for data capture process 202 according to an exemplary embodiment of the present invention. A database builder arrives at a facility associated with the provider client for storing data in step 300. For example, the facility may be a building, warehouse or storage unit in which the client stores or houses documents. The facility may include a division, branch or headquarters of the provider client, or it may be a separate site used exclusively, or in part, for data storage. The facility may be owned, operated, leased, managed, or rented by the provider client. Alternatively, the facility may be owned, leased, managed or rented by another entity performing services for the provider client. For example, the facility may be an outsourcing company that provides data storage services for the provider client.

Once technician 126 arrives at the facility associated with the provider client, he or she locates the documents to be gathered in step 302. Technician 126 scans the paper documents into an electronic format in step 304. In one embodiment of the present invention, technician 126 brings mobile and fixed scanning devices to the facility for scanning the documents. For example, technician 126 may arrive at the facility with a van, truck, trailer, or other unit containing scanning and collection equipment. Scanning equipment may include any fixed or mobile scanning devices. Such scanning devices would be well-known to those skilled in the art. In an embodiment of the present invention, the scanning equipment includes high speed scanners capable of quickly collecting large volumes of data. Such high-speed scanners may process the data at a rate of approximately 170 pages per minute. One skilled in the art will appreciate that the present invention is not limited to any particular scanning device or scanning rate.

For large volumes of historical documents or records, the database builder transports the records from the facility to the truck or trailer for scanning. For example, technician 126 transports a backplant or indexed collection of medical records from the facility into the van or trailer for processing. After scanning, the documents are returned from the truck or trailer to the facility. In an alternative embodiment, technician 126 scans the documents inside the facility using mobile scanning devices and/or other scanning devices located within the facility.

For scanning smaller volumes of data, such as scanning records that are added after an initial capture of the backplant, technician 126 uses mobile scanning equipment. For example, rather than transporting the document from the facility to a trailer outside the facility, technician 126 brings a mobile scanning device inside the facility to scan the documents. One of ordinary skill in the art will appreciate that technician 126 may choose to carry the documents from the facility to fixed scanning devices housed inside the trailer or use a combination of mobile and fixed scanning devices.

In another embodiment of the present invention, technician 126 scans the documents at the premises of the facility using equipment owned or leased by the facility. In yet another embodiment of the present invention, technician 126 uses scanning devices of database builder 120 as well as scanning devices of the facility, thereby scanning the documents in the fastest time possible.

By scanning the documents at the facility, the invention avoids chain of custody issues associated with off-site document processing and ensures that documents are returned to the facility. Scanning the documents at the facility also helps to ensure that the data is scanned in a secure environment and facilitates compliance with HIPAA.

In an alternative embodiment of the present invention, the provider client physically or electronically transports the documents to a location associated with or accessed by database builder 120, in a manner that complies with HIPAA.

After scanning the documents, technician 126 transmits the data from computer system 124 to network 150 over a secure connection in step 306. For example, in one embodiment of the present invention, technician 126 establishes a virtual private network (VPN) or secure shell (SSH) connection between the database builder and a File Transfer Protocol (FTP) server for tunneling or port forwarding the data. In one embodiment, FTP and SSH2 (Secure Shell version 2) protocols are used to establish the SSH connection. Preferably, all data tunneled through the SSH is encrypted during transit, resulting in a secure FTP session.

Although the data capture process is described above with respect to capturing hardcopy data, one of ordinary skill in the art will appreciate that the data capture process can include collecting data stored in electronic format from the client or another organization of interest to the client. For example, in an alternative embodiment, database builder visits the facility to gather data stored electronically in random access memory (RAM) device, a read only memory (ROM) device, a magnetic disk, an optical disk, or in any dynamic or static storage device.

One of ordinary skill in the art will also recognize that each of the steps in FIG. 3 may be contracted in a business associate agreement between the database builder and provider client. The business associate agreement may be customized for provider client or it may be a standardized agreement. For example, the business associate agreement may set forth the date(s), time(s), frequency, location(s) and type(s) of data capture, etc. The agreement may state whether scanning and data capture equipment is to be provided by the database builder or provider client, a third party or in some other manner. As described above, various pricing and billing arrangements can be implemented according to the present invention.

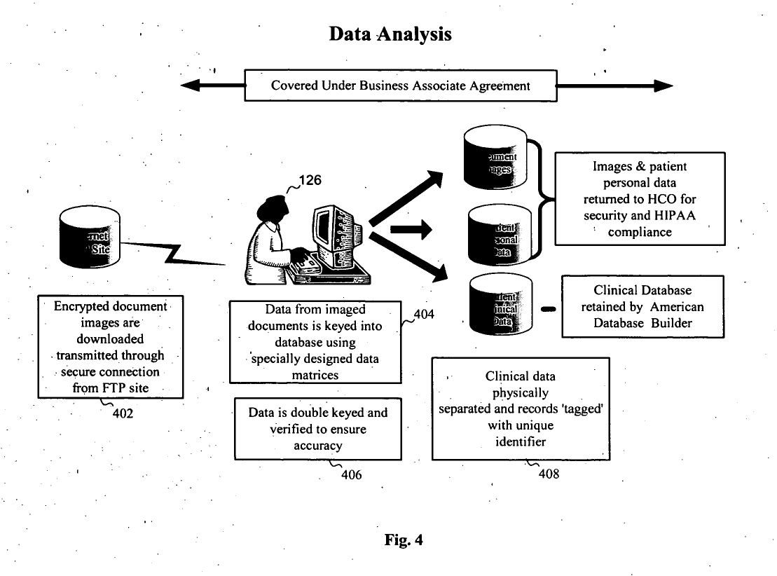

FIG. 4 is a schematic diagram of a data analysis process according to an exemplary embodiment of the present invention. As shown in FIG. 4, technician 126 downloads the encrypted data from the FTP server via a secure connection in step 402. The secure connection may be established via a VPN or SSH, as described above.

Once the data is downloaded and decrypted, technician 126 keys the data into one or more databases in step 404. In a preferred embodiment, technician 126 may key data from an imaged document into a plurality of specially designed data matrices. For example, technician 126 may key data from one document into a matrix containing patient clinical data, a matrix containing patient personal data, and a matrix containing document images. As shown in step 406, technician 126 may key each specially designed data matrix twice to ensure accuracy. For example, technician 126 may double-key patient personal data into a first and second patient personal data matrix, respectively.

Technician 126 then compares the first and second patient personal data matrices using document comparison software, such as the Compare tool in Microsoft Word or DeltaView, or by manually comparing the matrices. Any discrepancies noted during the comparison may be corrected to ensure accuracy. Verified versions of the matrix containing patient clinical data, the matrix containing patient personal data, and the matrix containing document images may be stored in separate databases. For example, as described above, clinical data may be stored in clinical outcomes database 130, personal data may be stored in first database 142 of other databases 140, and document images may be stored in second database 144 of other databases 140.

In a preferred embodiment of the invention, patient clinical data is retained by the database builder and stored in clinical outcomes database 130 of FIG. 1. In step 408, the data is tagged with unique identifiers if desired, thereby enhancing the provider client's ability to locate and evaluate various components of a record of its patient. For example, a unique identifier may be assigned to the matrices containing patient clinical data, personal data, and document images for a particular record of the provider client. The tags may be used to pull an entire record, containing clinical data, personal data, and document images, of a patient of provider client for the provider client's viewing.

For example, a computer program executing on computer system 122 can search for a matrix in each database 130, 142 and 144 containing a particular identifier, such as “XYZ53STY.” Computer system 122 retrieves a record in each of databases 130, 142 and 144 containing the identifier “XYZSTY053.” The three records resulting from the search (i.e., those records that contain the identifier “XYZ53STY”) are combined to form a complete medical record for a patient of provider client. In one embodiment of the present invention, the unique identifier includes a portion that relates to the identity of provider client, the identity of the patient, and an identity of the record of the patient. For example, in the “XYZ53STY” identifier example given above, “XYZ” may represent the identity of the provider client, “STY” may represent the identity of the patient of provider client XYZ, and “053” may represent a medical record belonging to provider client XYZ of patient STY. Using such identifiers, the present invention can restrict access to medical records beginning with “XYZ” to only provider client XYZ. One skilled in the art will recognize that numerous identifiers or matrices may be created and retained by the database builder within the scope and spirit of the present invention.

In another embodiment of the present invention, database builder 120 categorizes clinical data containing or relating to particular symptoms, treatments, pharmaceuticals, or other categories for use with data analysis tools accessed by all clients 110a-110c. For example, in one embodiment of the present invention, technician 126 tags clinical data associated with a particular pharmaceutical used during treatment. In this manner, data analysis tools can search for and locate a block of data relating to the pharmaceutical for a user of the tools. The user, a client, can evaluate the effectiveness of the pharmaceutical based upon the results. Similarly, technician 126 may tag clinical data associated with a particular treatment. A health care provider 110a may use the data analysis tools to search for and locate a block of data corresponding to the treatment and evaluate its effectiveness. Similarly, an insurer 110b may employ the data analysis tools to locate a block of data corresponding to various,treatments for a particular ailment, set of symptoms or diagnosis, and search for the most cost effective medical treatment.

In another embodiment of the present invention, data analysis tools perform data analysis without requiring any special tagging or notation of the data stored in clinical outcomes database 130. For example, the data analysis tools may search and retrieve records containing certain terms entered by a client or user, such as the name of a pharmaceutical, treatment, etc. The tools may allow multiple search terms to be used, including logical connectors such as “AND” and “OR.” Those skilled in the art would appreciate that more complex searches, including the use of wildcard characters can be used.

03 In an embodiment of the present invention, document images and patient personal data stored in other databases 140 may be retained by database builder 120, but accessed only by provider client. No third parties may view the data stored in other databases 140. For example, the database files corresponding to patient information and document images may be tagged so that only the provider client has access.

In another embodiment of the present invention, document images and patient personal data stored in other databases 140 are returned to provider client for security and HIPAA compliance. Images and patient personal data files are returned on disk or by EDU to the provider in the form of an electronic file containing digital images and a database containing patient personal data. The data may be returned in any suitable manner or format. For example, electronic data may be returned over a secure network connection or by a postal service. Similarly, hardcopy data may be returned by a postal service.

One of ordinary skill in the art will also recognize that each of the steps in FIG. 4 may be contracted in a business associate agreement by the database builder and provider client. The business associate agreement may be customized for provider client or it may be a standardized agreement. For example, the business associate agreement may set forth the identifiers to be tagged for provider client, the manner of delivery of images and patient personal data to provider client as well as other terms of the business arrangement.

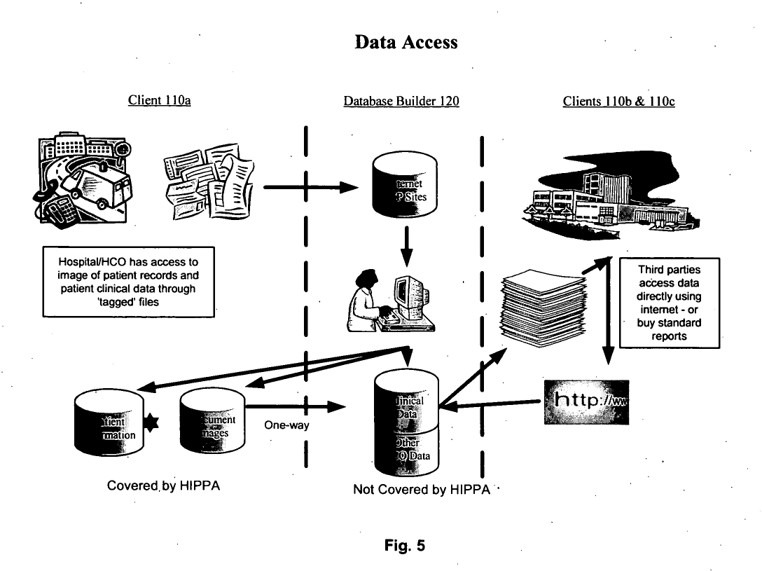

FIG. 5 is a schematic diagram of a data access process according to an exemplary embodiment of the present invention. In an embodiment of the present invention, database builder 120 varies the levels of data access provided to clients, such as the provider client and third parties, based upon the provider client's identity. As shown in FIG. 5, database builder 120 may provide additional data to the provider client (for example, health care provider 11oa) that is not available to third parties (for example, health care payers 110b and pharmaceutical companies 110c). In this embodiment, database builder 120 provides access to personal information, document images and clinical data of the provider client's patients to provider client 110a over a secure Internet FTP site. Provider client 110a may not view the personal information or document images of patients belonging to other health care providers. However, it may review the clinical data stored in database 130 that was provided by such other health care providers. Provider client 110a may review the clinical data of other health care providers over a secure connection or unsecure connection. Similarly, database builder 120 may provide access to clinical data stored in database 130 to third parties, health care payee 110b and pharmaceutical company 110c, over network 150 via an unsecured network connection.

In another embodiment of the present invention, provider client 110a gains access to a complete medical record by first logging into a secured site associated with the personal information and/or document image.

In another embodiment of the present invention, provider client is authorized to access complete records only while accessing other databases 140. In this embodiment of the present invention, the provider client cannot access other databases 140 while accessing clinical outcomes database 130. In this manner, the present invention provides additional security by preventing an unauthorized client from hacking into other databases 140 while the client legally accesses clinical outcomes database 130.

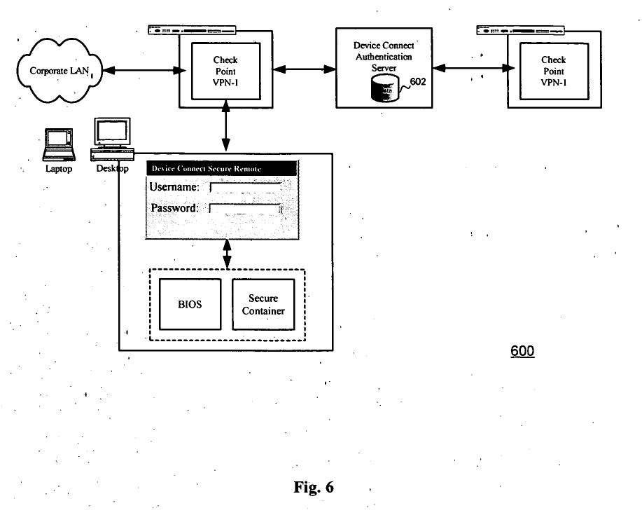

FIG. 6 is a schematic diagram of an exemplary data access system 600 for the provider client according to another embodiment of the present invention. Data access system 600 for the provider client includes BIOS level security. One such BIOS level security tool presently available is Device Connect. Device Connect validates whether a notebook, laptop, personal computer or other computer system is authorized to connect to the secure network. That is, in addition to validating user name and password, Device Connect validates whether a computer system associated with the user name and password contains an authorized identifying key. The authorized identifying key is a unique key that is embedded into a computer system when a computer system is enrolled or opted in with the Device Connect Authentication Server. The key may not be transferred to another device, even by transferring the hard drive or other computer system components. Further, the key is not exposed publicly.

If the computing system does not contain an authorized identifying key, the device is denied access to the secure network. Thus, Device Connect prevents a thief who steals user identification and a password from connecting to the network without an associated authorized device. If the thief steals a laptop, notebook or other computing system, Device Connect allows the stolen device or computing system to be de-activated or de-connected so that it cannot connect to the network any longer.

As shown in FIG. 6, provider client provides a username and password at a device connect secure remote. Check point VPN-1 is a VPN access point, such as a Check Point firewall. Device Connect Authorization Server is the central arbitrator for device identification and authorization. Device Connect Authorization Server may validate a username and password received from provider client 110a. Additionally, Device Connect Authorization Server may receive an identifier from a secure storage of computer system 105a. To ensure security, the identifier may be encoded before transmission to the Device Connect Authentication Server determines whether a unique identifier contained in a secure container within the hard drive of computer system 105a matches an identifier stored in a database of the Device Connect Authorization Server that is associated with the username and password.

Direct Connect Authentication Server generates the identifier when provider client 110a initially registers with the Device Connect Authentication Server. Registration may occur when provider client connects with computer system 105a and enters information in accordance with prompts from setup dialog boxes. The Device Connect Authentication server stores the identifier in a secure container of computing system 105a of provider client 110a and in database 602 of the server. To revoke access due to computer theft or employee departure, for example, a network administrator may locate the device on an authentication table in database 602 and revoke its access. An authorized user accesses the system by entering the appropriate URL into a web-browser. The user is then authenticated based on the Device Connect Authority that is set up for that computer. If the Device Connect Authentication is valid, the user will be asked to provide the User ID and Password in order to gain access to the system. -If the Device Connect Authentication fails the user session is terminated and an error message and error log generated.

In another embodiment of the invention, database builder 120 may share a portion of the revenue with each provider client based upon the number of patient records provided in the last few years, such as five years.

In this detailed description, systems and methods in accordance with embodiments of the present invention have been described with reference to specific exemplary embodiments. Accordingly, the present description and figures are to be regarded as illustrative rather than restrictive.

1. A method for providing a national medical database, comprising:
scanning a medical record at a facility of a provider client;
extracting clinical data from the record;
extracting personal data from the record;
storing the clinical data into a clinical outcomes database;
storing the personal data in a personal records database;
providing access to the personal records and clinical outcomes database to the provider client; and
providing access to only the clinical outcomes database to a second client.

2. The method of claim 1, further comprising:
analyzing the clinical data using data analysis tools; and
storing results of analyzing the clinical data into the clinical outcomes database.

3. The method of claim 1, further comprising extracting the clinical data at a premise of the provider client.

4. The method of claim 1, further comprising extracting the clinical data at a secure facility.

5. The method of claim 1, wherein extracting clinical data further includes encoding the clinical data with identifiers.

6. The method of claim 5, wherein identifiers include a patient's symptoms, treatment and pharmaceuticals use.

7. The method of claim 1, wherein personal data includes patient data protected under HIPAA and clinical data includes clinical data not protected under HIPAA.

8. A method for providing a national database, comprising:
scanning a record at a facility of a first client;
extracting a first data type from the record;
storing the first data type into a first database;
extracting a second data type from the record;
storing the second data type into a second database;
providing access to the first database to the first client and a second client, and
providing access to the second database to the first client only.

9. The method of claim 8, wherein the record is a medical record, the first data type is clinical data and the second data type is protected patient health information.

10. The method of claim 8, further comprising:
analyzing the first data type using data analysis tools; and
storing results of analyzing the first data type into the first database.

11. The method of claim 8, further comprising extracting the first and second data type at a premise of the provider client.

12. The method of claim 8, further comprising extracting the first and second data type at a secure facility.

13. The method of claim 8, wherein extracting the first data type further includes encoding the first data type with identifiers.

14. The method of claim 13, wherein identifiers include a patient's symptoms, treatment and pharmaceuticals use.

15. A system for providing a national medical database, comprising:
a high speed scanner for scanning a plurality of medical records at a facility of a provider client;
a clinical outcomes database for storing clinical data extracted from the plurality of records;
a personal records database for storing personal data extracted from the plurality of records; and
a processor for monitoring security of the clinical database and the personal database,
wherein the processor provides access to both the personal records and clinical outcomes database to the provider client, and
provides access to only the clinical outcomes database to a second client.

16. The system of claim 15, further comprising:
data analysis tools for analyzing the clinical data, wherein the clinical outcomes database stores results of analyzing the clinical data.

17. The system of claim 15, wherein the scanner is located at a premise of the provider client.

18. The system of claim 15, further comprising extracting the clinical data at a secure facility.

19. The system of claim 15, wherein extracting clinical data further includes encoding the clinical data with identifiers.
